(19) United States
(12) Patent Application Publication
(10) Pub. No.: US 2005/0128736 A1
(43) Pub. Date: Jun. 16, 2005

(54) Barricade light

(76) Inventor: Markus Frick, Reno, NV (US)

Correspondence Address: BROWN & MICHAELS, PC;400 M & T BANK BUILDING, 118 NORTH TIOGA ST, ITHACA, NY, 14850, US

(21) Appl. No.: 10/994,776

(22) Filed: Nov. 22, 2004

Related U.S. Application Data
(60) Provisional application No. 60/524,246, filed on Nov. 21, 2003.

(51) Int. Cl. F21S 8/00

(52) U.S. Cl. 362/145

(57) ABSTRACT

A barricade light having, in its preferred embodiments, three main components. First, a base having an upper housing with top and sides mating with a lower cover along an interface. Second, a light-bearing member bearing a light-producing element, with the light-bearing member being rotatably mounted to the top of the base. Third, lenses enclosing the light-bearing member, with the lenses also being rotatably mounted to the top of said base. In addition, the light-bearing member includes a shock-absorbing element intermediate its light-producing element and it's connection to the base, with the shock-absorbing element being preferably provided by a living hinge. Further, the light-bearing member is electrically connected to batteries in the base via an interface that allows uninhibited rotation of the light-bearing member and the lenses, which rotate in tandem. Finally, the base and its components are designed to inhibit and minimize water incursion and to otherwise safeguard critical components and aspects of the barricade light.

### REFERENCE TO RELATED APPLICATIONS

This application claims an invention which was disclosed in Provisional Application No. 60/524,246, filed Nov. 21, 2003, entitled “Barricade Light”. The benefit under 35 USC §119(e) of the U.S. provisional application is hereby claimed, and the aforementioned application is hereby incorporated herein by reference.

### BACKGROUND OF THE INVENTION

1. Field of the Invention

The invention pertains to the field of barricade lights. More particularly, the invention pertains to an LED barricade light where the LED providing illumination is mounted on a candlestick connected to the barricade light structure by a living hinge.

2. Description of Related Art

Barricades are often seen where it is necessary to block traffic from a particular area or hazard. Thus, barricades are often used to mark potholes or to divert traffic from a dangerous route or obstacle. As such barricades may not be easily visible at night or during difficult weather situations, they are often provided with battery powered barricade lights. These lights are usually pivotally mounted so as to be rotatable to some degree. This allows them to be turned in different directions as the need arises. They are also generally capable of operating in a flashing mode (so as to better attract attention). In recent years, with the development of LEDs capable of acting as energy efficient illumination sources, LEDs have increasingly replaced incandescent bulbs as the primary light source used in such structures. However, barricade light structures in current use are also deficient in terms of durability, resistance to shock and impact, and ease of repair and assembly.

### SUMMARY OF THE INVENTION

It is a primary goal of my invention to provide an LED barricade light that is durable, resistant to shock and impact, easy to assemble and repair, and weather resistant. This goal is accomplished by several innovations, including the following.

First, by providing an LED barricade light that has an improved candlestick design. This design incorporates a living hinge at its base that allows it to flex. It also has strategically placed locking tabs that ensure that the candlestick will remain in place and will continue to function even if the barricade light receives an impact severe enough to damage or break off the lens parts.

Second, by improving the connection between the candlestick and other components. For example, my use of a DC/DC jack allows uninhibited 360-degree freedom of rotation/movement. This eliminates the need for the type of “lens stopping” arrangements that are currently used to prevent existing lights from twisting off their contact wires when being rotated. Moreover, my design allows for on-barricade replacement without disassembly of the lower housing of the barricade light. Further, even if the candlestick should be damaged, my design protects all the other critical components such as the circuit board, photocell and DC connector. Another innovation related to connections between the candlestick and other components involves the use of an annular candlestick bearing surface interacting with a circumannular portion of the upper housing to provide smooth rotation and accurate guidance for mating with the lenses of the barricade light. Candlestick guide rails are also provided and can help guide the accurate mating of the lenses during re-assembly and repair.

Third, my invention is more weatherproof than existing designs. A strategic overlapping lens collar maximizes weatherproofing, and unique overhangs on the lower cover keep water out of the interior of the light whether it is right side up or upside-down. The lower cover is molded without perforations, again ensuring weather proofing. Further, even if water should enter the interior of the light, lower cover battery holders are provided to dissipate water and suspend the batteries above any gathered liquid. Moreover, the location of the circuitry and photocell on the battery chassis, below the standard points of impact, protects the important operating components from damage from impact or liquids.

### BRIEF DESCRIPTION OF THE DRAWING

FIG. 1 provides an exploded view of a barricade light prepared in accordance with the teachings of this invention.

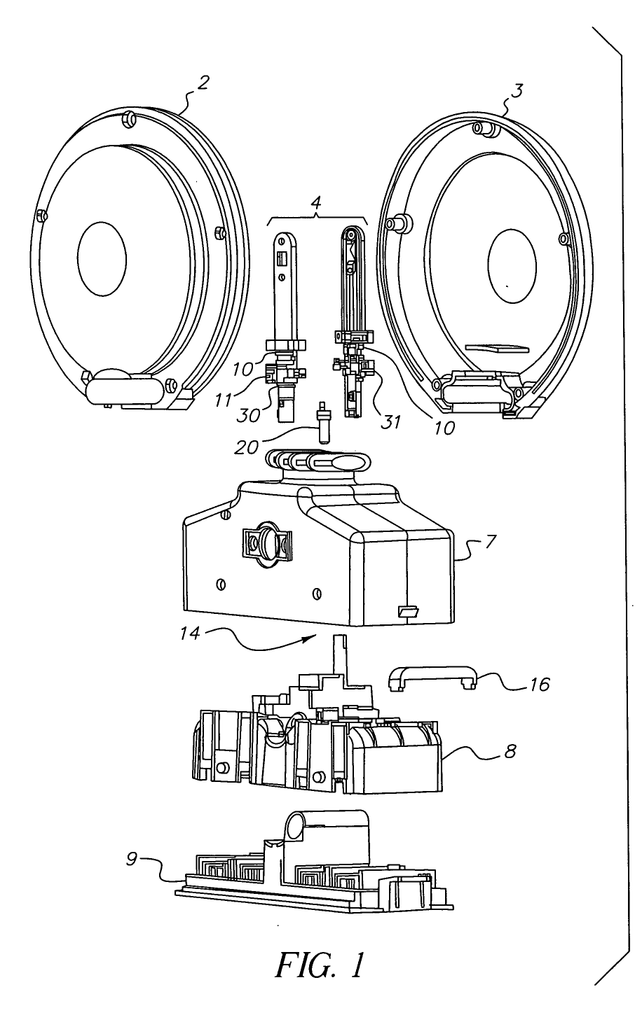

FIG. 2 provides a front elevational view of the barricade light illustrated in FIG. 1, with frontal lens removed.

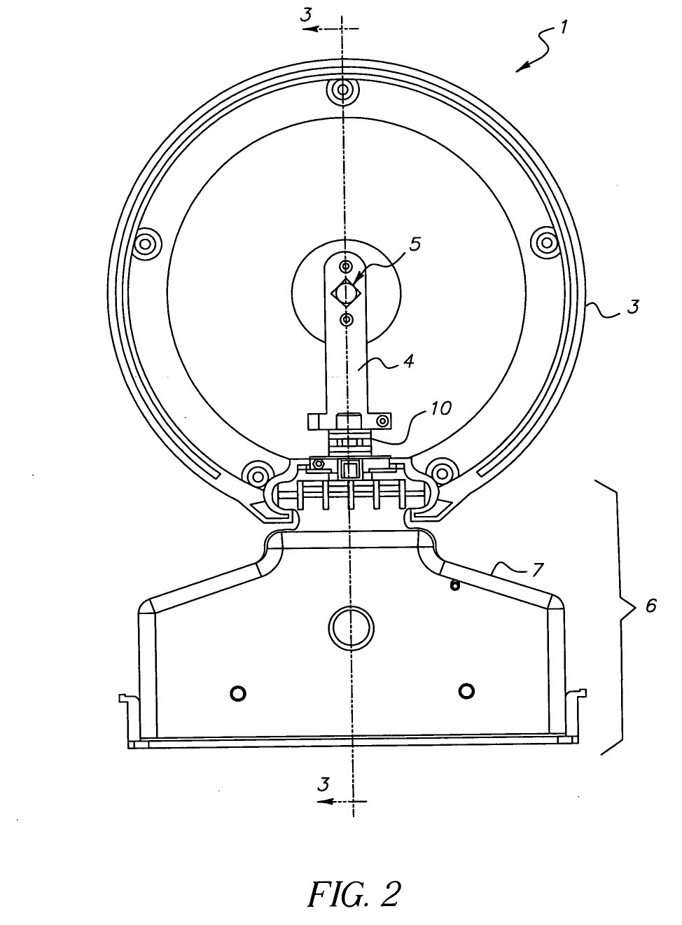

FIG. 3 provides a cross-sectional view taken along line 3-3 of FIG. 2.

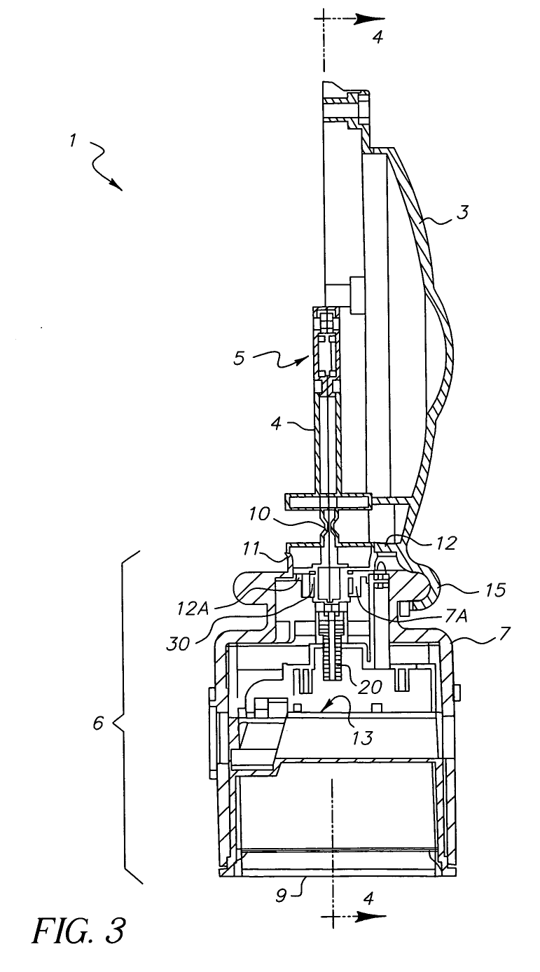

FIG. 4 provides a cross-sectional view taken along line 414 of FIG. 3.

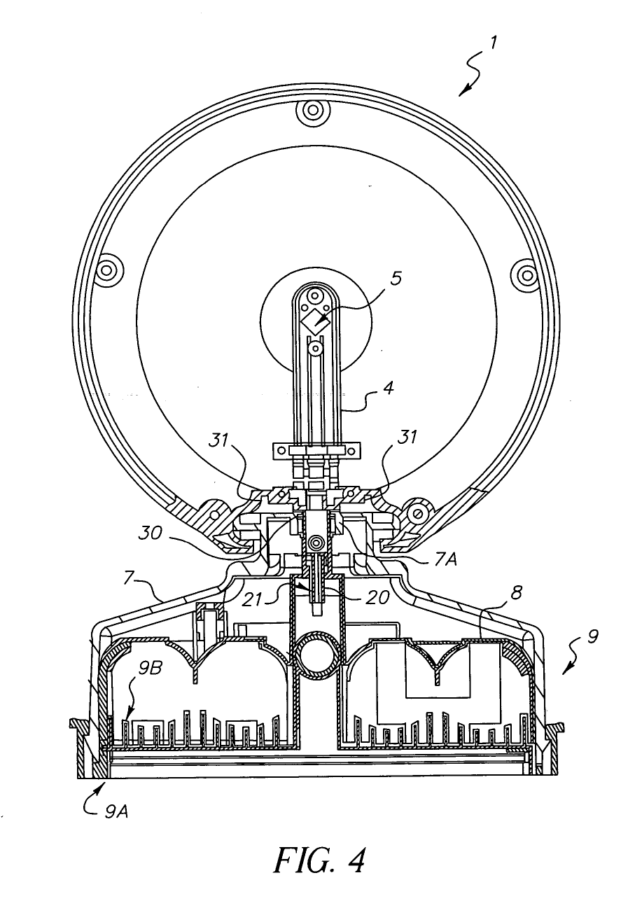

FIG. 5 provides a side view of the barricade light illustrated in FIG. 1 with lens removed, illustrating the flexible nature of the candlestick bearing the LED for the light.

FIG. 6 provides a more detailed view taken from FIG. 3.

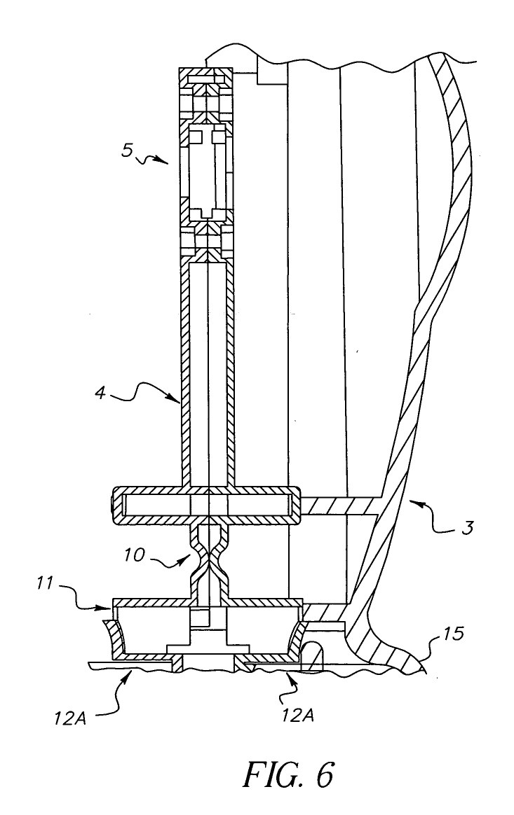

### DETAILED DESCRIPTION OF THE INVENTION

As illustrated in the drawing figures, my invention is a barricade light 1 that includes front and rear lenses 2, 3 for a light-bearing member (candlestick 4) bearing a light producing element (LED 5). These are rotatably mounted on a base 6 such that candlestick 4 rotates in tandem with lenses 2, 3 so as to retain its orientation with respect thereto. Base 6 includes an upper housing 7 that extends over lower portions of the base 6 such as battery chassis 8, and a lower cover 9. These basic parts include and incorporate many new and useful innovations.

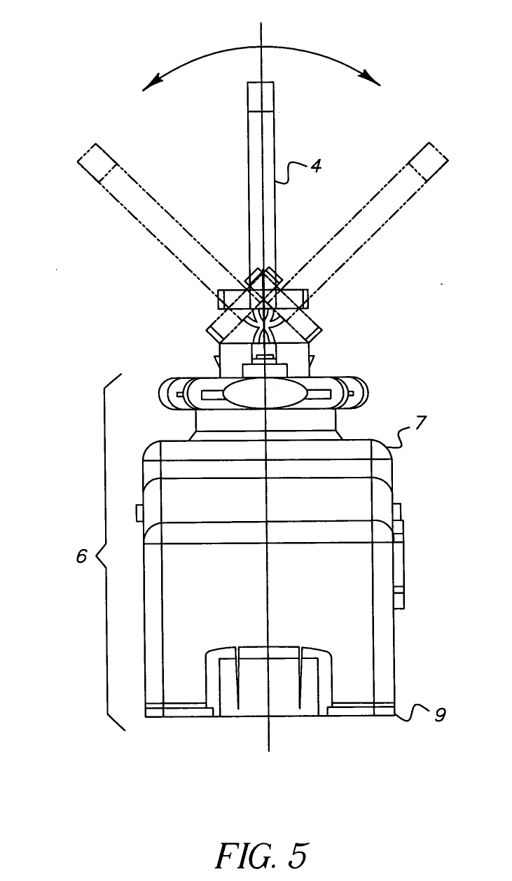

Many of these innovations relate to the candlestick 4. For example, my improved candlestick 4 design incorporates a living hinge 10 at its base that allows it to flex (see, e.g., FIG. 5) if the lens surface should experience a catastrophic impact. Furthermore, strategically placed locking tabs 11 on the candlestick 4 frictionally interfere with mating tabs on the inside of the upper housing 12A and the lowest surface of the lens' neck flange 12B (below the most common point of breakage) while anchored in the battery chassis. This ensures that the candlestick 4 will remain in place and will continue to function even if the barricade light 1 receives an impact severe enough to damage or break off the lens parts. These developments will allow the light 1 to continue to function and provide some level of warning even after severe damage that would render existing products inoperable.

Other innovations have been made with regard to the connection between the LED candlestick 4 and other components. For example, my mode of connection (or connection interface) uses a DC/DC jack 20 that allows uninhibited 360 degree freedom of rotation/movement and eliminates the need for the type of “lens stopping” arrangements that are currently used to prevent existing lights from twisting off their contact wires when being rotated. Furthermore, this design guarantees that there will be no strain related failures related to such wires, such as the pinching or severing of wires during assembly, disassembly or repair that can cause loss of electrical contact between the LED 5 and its batteries.

Repair and replacement of lenses 2, 3 (and candlestick 4, in the unlikely event it should be needed) can also take place without opening the housing in the field. Thus, my design allows for on-barricade replacement without disassembly of base 6. Further, even if the candlestick 4 should be damaged, my design protects all the other critical components inside the upper housing 7 (i.e.-circuit board 13, photocell 14, and female DC connector 21); hereby ensuring less potential points of failure that would need diagnosis. In short, my light 1 would have to be completely demolished for all the other critical electronic components to be damaged. Also, the replacement candlestick 4 of my invention is so compact and simple it can be carried in a pocket for easy application in the field.

Another innovation related to connections between the LED candlestick 4 and other components involve the candlestick bearing surface 30 and candlestick guide rails 31. Annular candlestick bearing surface 30 interacts with a circumannular portion 7A of the upper housing 7 to provide smooth rotation and accurate guidance for mating with lenses 2, 3. Further, even after the candlestick 4 is mated with the upper housing 7 and battery chassis 8 during assembly, the candlestick guide rails 31 can help by guiding the accurate mating of the lenses 2, 3 during re-assembly and repair. Once the light 1 is assembled, these guide rails 31 also serve as a further retention device which, once again, is below the lens neck flange (the lowest point of potential breakage). This design ensures that the candlestick 4 is held properly in place and is correctly oriented with the lenses, but prevents the candlestick 4 from being ripped out should the lenses 2, 3 be severed from the body due to abuse.

In addition, my invention is more weatherproof than existing designs. Candlestick 4 and upper housing 7 mate with strategic overlapping lens collar 15 to maximize weatherproofing. The interface between upper housing 7 and lower cover 9 includes overlapping/overhanging portions such as overhangs 9A on the lower cover 9 that keep water out of the interior of base 6, whether it is right side up or upside-down. Unlike other products in the industry, the lower cover is molded without perforations, again ensuring weather proofing. Further, even if water should enter the interior of the light 1 (through, e.g., extended submersion), the vertical supports 9C of lower battery holders 9B are designed to allow water to drain away from any batteries held therein, and suspend the batteries above any gathered liquid.

Moreover, the location of the circuitry 13 and photocell 14 on the battery housing (battery chassis 8), below the standard points of impact, protects the important operating components from damage from impact or liquids. The photocell 14 is anchored in the battery chassis 8, not on the candlestick 4, while supported by the upper housing 7. LED wiring and DC/DC jack 20 are all enclosed for protection. A slide switch is covered by a moveable slide switch cover 16 which protects the switch mechanism from damage or intrusion. Finally, my durable exterior tab-lock design offers access to the battery chassis 8 with or without a screwdriver.

However, notwithstanding the foregoing description of a particular embodiment, my invention is subject to numerous variations. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A barricade light, comprising:
a base;
a light-bearing member bearing a light producing element;
lenses enclosing said light-bearing member, said lenses being rotatably mounted to said base; and
wherein said light-bearing member includes a shock-absorbing element intermediate a portion bearing its light producing element and the light-bearing member's connection to said base.

2. A barricade light as described in claim 1, wherein a living hinge acts as said shock-absorbing element for the light-bearing member.

3. A barricade light as described in claim 2, wherein said living hinge allows the light-bearing member to tilt towards said lenses.

4. A barricade light as described in claim 1, wherein said light-bearing member is anchored to said base so as to remain attached thereto even if said lenses are broken off of said base.

5. A barricade light as described in claim 1, wherein said light-bearing member is rotatably mounted to said base and interacts with said lenses so as to rotate in tandem therewith.

6. A barricade light as described in claim 1, wherein said light-bearing member is electrically connected to batteries in said base via an interface that allows uninhibited rotation of the light-bearing member and the lenses.

7. A barricade light as described in claim 6, wherein a DC/DC connection allows uninhibited rotation of the light-bearing member.

8. A barricade light as described in claim 1, wherein said base includes an upper housing with top and sides mating with a lower cover along an interface.

9. A barricade light as described in claim 8, wherein said base includes a lower cover with supports for any batteries disposed thereon, which supports hold any such batteries above a bottom of the base to avoid exposing said batteries to any water trapped in the base.

10. A barricade light as described in claim 9, wherein said supports allow water to drain away from any battery disposed therein.

11. A barricade light as described in claim 8, wherein said lower cover is molded without perforations and the interface between said upper housing and said lower cover inhibits water from entering the base via said interface.

12. A barricade light as described in claim 8, wherein at least one of circuitry for operation of the barricade light and other parts critical to its operation is located in upper portions of the upper housing.

13. A barricade light as described in claim 8, further comprising a battery chassis for covering any batteries disposed on the lower cover, which chassis supports at least one of circuitry for operation of the barricade light and other parts critical to its operation in upper portions of the upper housing.

14. A barricade light as described in claim 8, further comprising a batter chassis for covering any batteries disposed on the lower cover, which chassis inhibits any water above the chassis from reaching any batteries disposed on the lower cover and where interfaces between said chassis, said lower cover, and said upper housing inhibit water from reaching any batteries disposed on the lower cover via said interfaces.

15. A barricade light, comprising:
a base;
a light-bearing member bearing a light producing element;
lenses enclosing said light-bearing member, said lenses being rotatably mounted to said base; and
wherein said light-bearing member is electrically connected to batteries in said base via an interface that allows uninhibited rotation of the light-bearing member and the lenses.

16. A barricade light as described in claim 15, wherein a DC/DC connection allows uninhibited rotation of the light-bearing member.

17. A barricade light as described in claim 15, wherein said light-bearing member is rotatably mounted to said base and interacts with said lenses so as to rotate in tandem therewith.

18. A barricade light as described in claim 16, wherein said light-bearing member includes a shock-absorbing element intermediate a portion bearing its light producing element and the light-bearing member's connection to said base.

19. A barricade light as described in claim 18, wherein a living hinge acts as said shock-absorbing element for the light-bearing member.

20. A barricade light as described in claim 19, wherein said living hinge allows the light-bearing member to tilt towards said lenses.

21. A barricade light as described in claim 15, wherein said light-bearing member is anchored to said base so as to remain attached thereto even if said lenses are broken off of said base.

22. A barricade light as described in claim 15, wherein said base includes an upper housing with top and sides mating with a lower cover along an interface.

23. A barricade light as described in claim 22, wherein said base includes a lower cover with supports for any batteries disposed thereon, which supports hold any such batteries above a bottom of the base to avoid exposing said batteries to any water trapped in the base.

24. A barricade light as described in claim 23, wherein said supports allow water to drain away from any battery disposed therein.

25. A barricade light as described in claim 23, wherein said lower cover is molded without perforations and the interface between said upper housing and said lower cover inhibits water from entering the base via said interface.

26. A barricade light as described in claim 23, wherein at least one of circuitry for operation of the barricade light and other parts critical to its operation is located in upper portions of the upper housing.

27. A barricade light as described in claim 23, further comprising a battery chassis for covering any batteries disposed on the lower cover, which chassis supports at least one of circuitry for operation of the barricade light and other parts critical to its operation in upper portions of the upper housing.

28. A barricade light as described in claim 23, further comprising a battery chassis for covering any batteries disposed on the lower cover, which chassis inhibits any water above the chassis from reaching any batteries disposed on the lower cover and where interfaces between said chassis, said lower cover, and said upper housing inhibit water from reaching any batteries disposed on the lower cover via said interfaces.

29. A barricade light, comprising:
a base having an upper housing with top and sides mating with a lower cover along an interface;
a light-bearing member bearing a light-producing element, which light-bearing member is rotatably mounted to the top of said base;
lenses enclosing said light-bearing member, said lenses being rotatably mounted to the top of said base;
wherein said light-bearing member includes a shock-absorbing element intermediate a portion bearing its light producing element and the light-bearing member's connection to said base, said shock-absorbing element being provided by a living hinge;
wherein said light-bearing member interacts with said lenses so as to rotate in tandem therewith; and
wherein said light-bearing member is electrically connected to batteries in said base via an interface that allows uninhibited rotation of the light-bearing member and the lenses.

30. A barricade light as described in claim 29, wherein said living hinge allows the light-bearing member to tilt towards said lenses.

31. A barricade light as described in claim 29, wherein said light-bearing member is anchored to said base so as to remain attached thereto even if said lenses are broken off of said base.

32. A barricade light as described in claim 29, wherein a DC/DC connection allows uninhibited rotation of the light-bearing member.

33. A barricade light as described in claim 29, wherein said lower cover includes supports for any batteries disposed thereon, which supports hold any such batteries above the lower cover to avoid exposing any said batteries to any water trapped in the base.

34. A barricade light as described in claim 33, wherein said supports allow water to drain away from any battery disposed therein.

35. A barricade light as described in claim 29, wherein said lower cover is molded without perforations and the interface between said upper housing and said lower cover inhibits water from entering the base via said interface.

36. A barricade light as described in claim 29, wherein at least one of circuitry for operation of the barricade light and other parts critical to its operation is located in upper portions of the upper housing.

37. A barricade light as described in claim 29, further comprising a battery chassis for covering any batteries disposed on the lower cover, which chassis supports at least one of circuitry for operation of the barricade light and other parts critical to its operation in upper portions of the upper housing.

38. A barricade light as described in claim 29, further comprising a battery chassis for covering any batteries disposed on the lower cover, which chassis inhibits any water above the chassis from reaching any batteries disposed on the lower cover and where interfaces between said chassis, said lower cover, and said upper housing inhibit water from reaching any batteries disposed on the lower cover via said interfaces.
